(19) United States
(12) Patent Application Publication
(10) Pub. No.: US 2022/0119125 A1
(43) Pub. Date: Apr. 21, 2022

(54) DISTANT MEASUREMENT SYSTEM FOR LOCATING POWERLINE MARKER BALL POSITIONS WITH RESPECT TO LONGITUDINAL DISPLACEMENT

(71) Applicant: Olympic Aero Services, Inc., Brinnon, WA (US)

(72) Inventors: Michael D. Reynolds, Olympia, WA (US); David C. Barton, Ridgefield, WA (US)

(73) Assignee: Olympic Aero Services, Inc., Brinnon, WA (US)

(21) Appl. No.: 17/443,729

(22) Filed: Jul. 27, 2021

Related U.S. Application Data
(60) Provisional application No. 63/037,442, filed on Jun. 10, 2020.

(51) Int. Cl. B64D 43/00; G01S 19/51; G01C 23/00

(52) U.S. Cl. CPC B64D 43/00; G01C 23/00; G01S 19/51

(57) ABSTRACT

A distance measurement location control system for guiding a helicopter pilot to locate powerline marker ball positions with respect to longitudinal displacement. A location control assembly communicates with a microprocessor module (MCU) onboard the location control assembly. A computer device is configured to receive and transmit setup data from and to the location control assembly. A GNSS module onboard the location control assembly is electrically connected to the MCU. A display onboard the location control assembly is connected to a first serial data line from the MCU to receive GNSS data. A global satellite communication network module onboard the location control assembly is electronically coupled to a second serial data line from the MCU to provide flight information. The display operates to dynamically guide a helicopter pilot to a number of powerline ball locations in a precise manner.

This application claims the benefit of U.S. provisional patent application Ser. No. 63/037,442 filed on Jun. 10, 2020, which is incorporated herein by this reference in its entirety.

### TECHNICAL FIELD

The present invention relates to a measurement method and system for locating markers with respect to longitudinal displacement. More particularly, the method and system are directed to guide a helicopter pilot to a predetermined placement location of powerline balls using GNSS data.

### BACKGROUND

Locating powerline marker balls (sometimes called aerial visibility balls) on hypertension high-voltage power lines is often done using a helicopter to first mark the positions and, in a second operation, transport an aerial lineman for installing the powerline marker balls. Powerline marker ball locations are typically spaced relative to an initial distance with respect to a first tower. Powerline marker balls are ideally installed at substantially equally spaced longitudinal distances along the powerline in accordance with industry regulations.

Typical distance tolerances around the specified locations are about 5 feet. As a result, it is not possible for the helicopter pilot to use a commercial global positioning system (GPS) as navigation to locate the powerline marker balls since the accuracy of GPS is about 15 to 20 feet. Currently, to attain the specified tolerances, a ground crew using triangulation methods measures distances and guides a helicopter pilot to specified powerline marker ball locations. This is a costly time consuming and labor intensive method.

### BRIEF SUMMARY OF THE DISCLOSURE

This summary is provided to introduce, in a simplified form, a selection of concepts that are further described below in the Detailed Description. This summary is not intended to identify key features of the claimed subject matter, nor is it intended to be used as an aid in determining the scope of the claimed subject matter.

A distance measurement location control system for guiding a helicopter pilot to locate powerline marker ball positions with respect to longitudinal displacement is provided. A location control assembly communicates with a microprocessor module (MCU) onboard the location control assembly. A computer device is configured to receive and transmit setup data from and to the location control assembly. A GNSS module onboard the location control assembly is electrically connected to the MCU. A display onboard the location control assembly is connected to a first serial data line from the MCU to receive GNSS data. A global satellite communication network module onboard the location control assembly is electronically coupled to a second serial data line from the MCU to provide flight information. The display operates to dynamically guide a helicopter pilot to a number of powerline ball locations in a precise manner.

### BRIEF DESCRIPTION OF THE DRAWINGS

While the novel features of certain embodiments of the invention are set forth with particularity in the appended claims, the invention, both as to organization and content, will be better understood and appreciated, along with other objects and features thereof, from the following detailed description taken in conjunction with the drawings, in which:

FIG. 1 schematically shows an example of a distance measurement system for guiding a helicopter pilot to locate powerline ball positions.

FIG. 2 schematically shows an enlarged view of an example of a location control assembly.

FIG. 3 schematically shows a high tension line tower structure and a partial powerline where powerline marker balls have been installed.

FIG. 4 schematically shows an example of a display used in the location guidance assembly.

FIG. 5 schematically shows a series of displays visually representing distance to target, where the target is a powerline marker ball location.

FIG. 6 schematically shows an example of ground station information sent from a global satellite communication network.

FIG. 7 schematically shows an example of a location control assembly mounted in a helicopter.

FIG. 8 schematically shows a flow diagram of the method employed by a distance measurement system for guiding a helicopter pilot to locate powerline ball locations.

FIG. 9 schematically shows a flow diagram of further actions employed by the method for guiding a helicopter to predetermined powerline ball locations.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION

The following disclosure describes a method and system for longitudinal measurement using an aerial vehicle. Several features of methods and systems in accordance with example embodiments are set forth and described in the figures. It will be appreciated that methods and systems in accordance with other example embodiments can include additional procedures or features different than those shown in the figures. Example embodiments are described herein with respect to a method and system directed to the system utilizing GNSS for guiding a helicopter pilot to a predetermined location. However, it will be understood that these examples are for illustrating the principles, and that the invention is not so limited.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example,” “an example embodiment,” “one embodiment,” “an embodiment” or combinations and/or variations of these terms means that a particular feature, structure or characteristic described in connection with the embodiment or example is included in at least one embodiment or example of the present disclosure. Thus, the appearances of the phrases “in one example” or “in an example” in various places throughout this specification are not necessarily all referring to the same example embodiment or example. Furthermore, the particular features, structures, or characteristics may be combined in any suitable manner in one or more embodiments or examples.

### Definitions

Generally, as used herein, the following terms have the following meanings:

The articles “a” or “an” and the phrase “at least one” as used herein refers to one or more.

“Bluetooth®” technology, as used herein means a commercially available low-power wireless connectivity technology used to stream audio, transfer data and broadcast information between devices. Bluetooth® technology is a wireless technology standard for exchanging data between fixed and mobile devices over short distances using short-wavelength UHF radio waves in the industrial, scientific and medical radio bands, for example, from 2.400 to 2.485 GHz. This technology is available from Bluetooth SIG, Inc. of Kirkland, Wash.

ANT is an ultra-low power (ULP) wireless networking protocol which enables objects from everyday life to connect with each other similar to Bluetooth® technology.

As used in the specification, the term “global satellite communication network” means a plurality of satellites interconnected by a plurality of satellite-to-satellite communication links. Each of the plurality of satellites is configured to communicate with at least one ground station using respective ground-satellite communication links. One provider of such a network is Iridium Satellite LLC of McLean, Va. 22102 US.

As used herein, NMEA means a specification developed by the National Marine Electronics Association (NMEA) that defines the interface between various pieces of marine electronic equipment such as echo sounder, sonars, anemometer, gyrocompass, autopilot, GPS receivers and many other types of instruments. An “NMEA SENTENCE” consists of sentences, the first word of which, called a data type, defines the interpretation of the rest of the sentence. Each Data type would have its own unique interpretation and is defined in the NMEA standard.

As used herein, “plurality” is understood to mean more than one. For example, a plurality refers to at least two, three, four, five, ten, 25, 50, 75, 100, 1,000, 10,000 or more.

As used in this specification, the terms “computer”, “processor” and “computer device” encompass a personal computer, a tablet computer, a smart phone, a microcontroller, a microprocessor, a field programmable object array (FPOA), a digital signal processor (DSP), an application-specific integrated circuit (ASIC), a field programmable gate array (FPGA), a programmable logic array (PLA), or any other digital processing engine, device or equivalent capable of executing software code including related memory devices, transmission devices, pointing devices, input/output devices, displays and equivalents.

“Obtaining” is understood herein as manufacturing, purchasing, or otherwise coming into possession of.

### EXAMPLE EMBODIMENTS

In one aspect, the longitudinal distance measurement system disclosed herein features several advantages over currently available methods and systems. The system and method disclosed herein utilizes GNSS (high accuracy GPS) with an accuracy of about 1 foot. A control module collects the GPS signal and manipulates this GNSS data so that an initial location is determined, initial and subsequent distances are determined, and a serial data signal is generated for display on an LCD screen. The module also monitors an input switch that provides a signal to the module when a ball has been located or when the system should be paused. A display provides an alpha numeric display indicating distance to target etc.

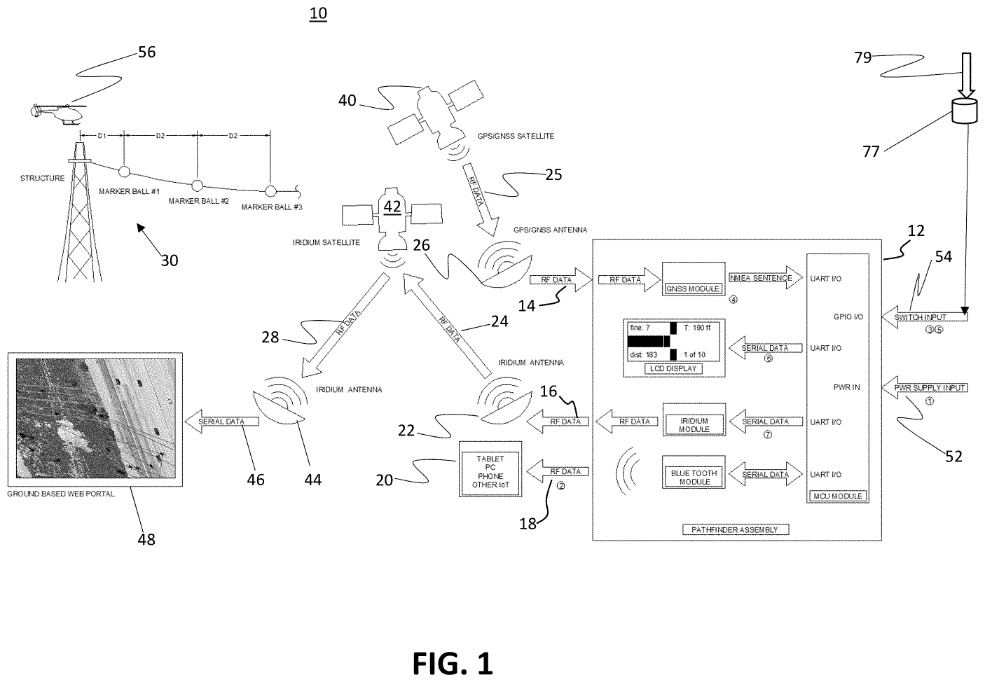

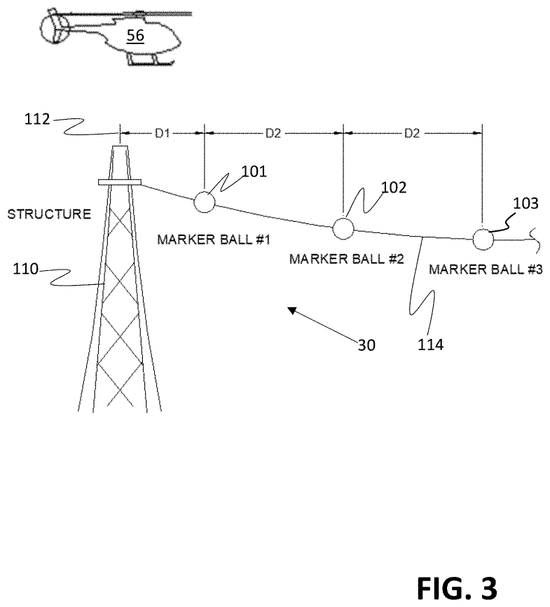

Referring now to FIG. 1, an example of a distance measurement system for guiding a helicopter pilot to locate powerline ball positions is shown. A distance measurement system for guiding a helicopter pilot to locate powerline marker ball positions with respect to longitudinal displacement 10 includes a location control assembly 12 that communicates with a computer device 20, a GNSS satellite system 40 and a global satellite communication network 42. A ground based web portal 48 receives serial data from the global satellite communication network 42. A helicopter 56 is guided by the control assembly 12 operating in combination with the computer device 20 and the GNSS satellite system 40 to locate and install a plurality of powerline marker balls 101,102,103 (as shown in FIG. 3) onto each of a plurality of predetermined locations using spacing D1, D2, D2, etc. along the transmission line structure 30. The distance control assembly 12 includes a first input for RF data 14, a first output for RF data 16 and a second output for RF data 18.

In one example, GNSS data is requested and received through a first antenna 26 receiving a first set of GNSS RF data 25. Global satellite communications data is transmitted through a second antenna 22 transmitting global RF data 24 to the global satellite network 42. The global satellite network 42 in turn transmits global positioning and other flight data to a third antenna 44 which relays the received data as serial data 46 to the ground station 48.

Power is supplied to the location control assembly 12 through a power supply input 52. A switch input 54 is activated by an operator, such as a helicopter pilot, providing pressure 79 to a pushbutton 77 or the like which sends an activation signal to the switch input 54.

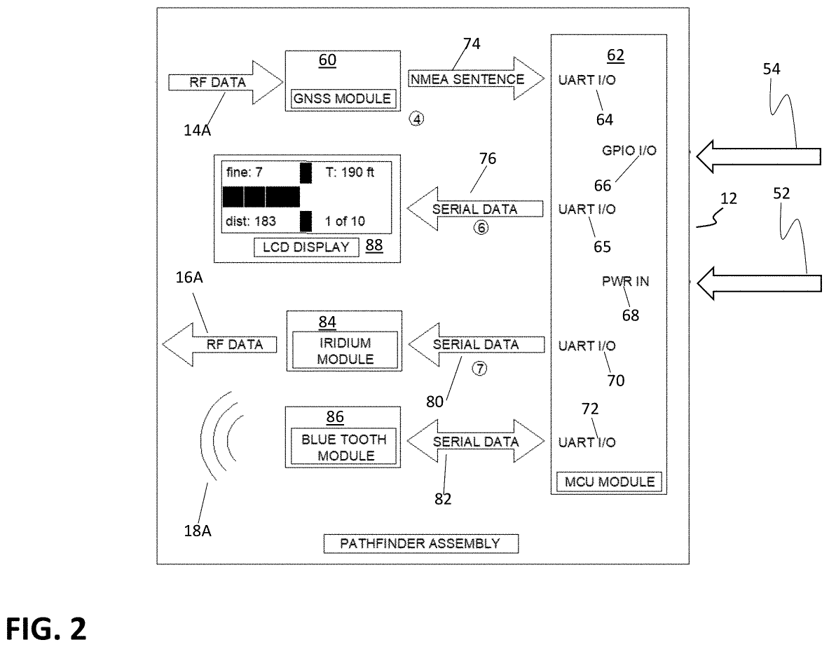

Referring now to FIG. 2, an enlarged view of an example of a location control assembly is schematically shown. In one example, the location control assembly 12 includes an MCU module 62. Electrically coupled to the MCU module 62 are a GNSS module 60, an LCD display 88, a global satellite communication network module 84, and a low-power wireless connection module 86. The MCU module 62 includes a first universal asynchronous receiver-transmitter (UART I/O) port 64, a general-purpose input/output (GPIO I/O) port 66, a second UART I/O port 65, a power input (PWR IN) 68, a third UART I/O port 70, and a fourth UART I/O port 72.

In one example, the GNSS module 60 is coupled at NMEA SENTENCE 74 to the MCU 62 to transmit the NMEA SENTENCE information to the first UART I/O 64. NMEA SENTENCE information his explain further below with reference to Table 1. The second UART I/O port 65 is configured to transmit output serial data 76 to the LCD display 88. Serial data 80 is transmitted by third UART I/O port 70 output is coupled to the global satellite communication network module 84. Serial data 82 is transmitted and received by low-power wireless connection module 86 and the fourth UART I/O port 72. A first RF DATA signal 14A is transmitted to GNSS module 60. A second RF DATA signal 16A is transmitted by the global satellite communication network module 84. The low-power wireless connection module 86 transmits wireless information 18A.

In one example, the GNSS module 60 continuously receives location data via the first RF data line 14A and transmits NMEA sentences 74 to the MCU 62 via the first UART I/O 64. A NMEA sentence, contains a variety of GPS data. Each NMEA sentence contains different information, organized by logical groupings. This system utilizes NMEA string RMC, “the recommended minimum”. One example of information contained in string RMC is shown below in Table 1.

TABLE 1
RMC - NMEA has its own version of essential gps pvt (position, velocity, time) data.
$GPRMC,123519,A,4807.038,N,01131.000,E,022.4,084.4,230394,033.1,W*6A

| | |
|---|---|
| Where: | |
| RMC | Recommended Minimum sentence C |
| 123519 | Fix taken at 12:35:19 UTC |
| A | Status A=active or V=Void. |
| 4807.038,N | Latitude 48 deg 07.038′ N |
| 01131.000,E | Longitude 11 deg 31.000′ E |
| 022.4 | Speed ever the ground in knots |
| 084.4 | Track angle in degrees True |
| 230394 | Date - 23rd of March 1994 |
| 003.1,W | Magnetic Variation |
| *6A | The checksum data, always begins with * |

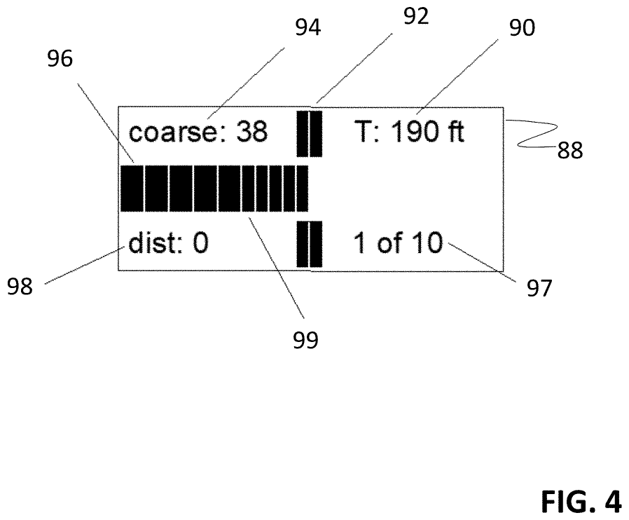

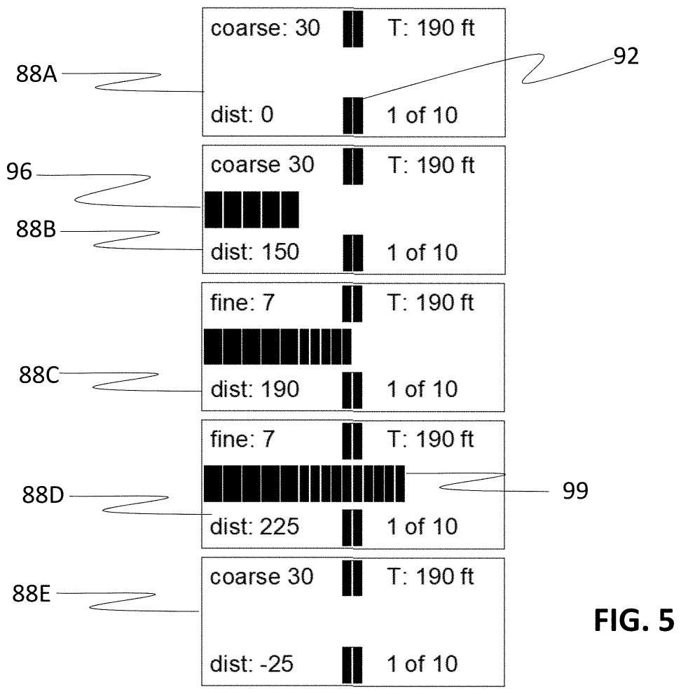

The MCU 62 is configured to parse out the desired information which is stored as variables within software programmed into the MCU. The helicopter is positioned at the structure and the pilot pushes the start switch 77. This initial location is stored as L1 within the MCU. As the helicopter moves, the current location L2 is subtracted from L1 and the absolute value displacement |L2−L1| is determined for distance. To convert the latitude coordinate to distance, the latitude is multiplied by the cosine of the latitude (degrees) converted to radians and then the hypotenuse (distance) is calculated by the modified latitude and longitude displacements. The stored values of D1, D2 are utilized to drive the LCD to display the selected fields and adjust the sliding bar graph as the target is approached (See FIG. 4 and FIG. 5 for display details).

Referring now to FIG. 3, a high tension line tower structure and a partial powerline where powerline marker balls have been installed is schematically shown. The structure 30 includes a tower 110, a powerline 114 connected to the tower 110 and a plurality of marker balls 101, 102, 103 installed on the powerline 114. It will be understood that this is only showing a partial powerline structure with one tower and one section of a powerline representing a long series of towers and powerlines. In actuality many towers are used to span a power grid system and each powerline is connected in series from one tower to the next. Although not shown, it will be understood by those skilled in the art having the benefit of this disclosure that at least two powerlines are usually connected between towers. Helicopter 56 carries a location control assembly 12 for marking the starting reference 112 and guidance to the predetermined distances D1, D2, D2 for locating and installing the plurality of marker balls. Predetermined distance D1 is measured from the starting reference 112. Predetermined distance D2 is measured from the location of each preceding marker ball. In this way, the marker balls are installed according to predetermined longitudinal distance specifications.

Referring now to FIG. 4, an example of a snapshot of a display used in the location guidance assembly is schematically shown. A snapshot or state of the display 88 at a particular point in time for the purposes of explaining the various display features includes a coarse resolution represented by a plurality of segments 96 and indicia 94 reading “coarse”, a numeric display 90 of the target distance (distance to ball location), indicia representing distance traveled from the starting point 98, (last ball or tower start location and the number of the ball location at the next target 97).

In a typical scenario, as the target is approached the resolution of a narrow segment (fine) 99 appears. When in use, the bar segments will appear wide 96 up to 80% of the target distance 90 and narrow 99 for the remaining 20% and beyond. The resolution is automatically adjusted depending upon the distance to target value. It will be understood that while the display in this example is referenced as an LCD display, that any equivalent visual display may be used such as a heads up display, flat screen display and the like. Audio signals may also be used either alone or in combination with a visual display to indicate distance to target.

Referring now to FIG. 5, an example of a sequence of display snapshots representing displays at a sequence of distances of helicopter travel from a start location to other longitudinal locations along a transmission line is illustrated. Display 88A represents the start of location activity. Display 88B represents the appearance of the display when the helicopter 56 used for powerline ball placement has traveled 150 feet toward first target. Display 88C represents the appearance of the display when the helicopter 56 has arrived at a target location. For purposes of this disclosure it will be understood that the target location is the predetermined location for installation of a powerline marker ball. Display 88D represents the appearance of the display when the helicopter 56 has gone past the target location. Display 88E represents the appearance of the display when the helicopter 56 is 25 feet back from the starting point.

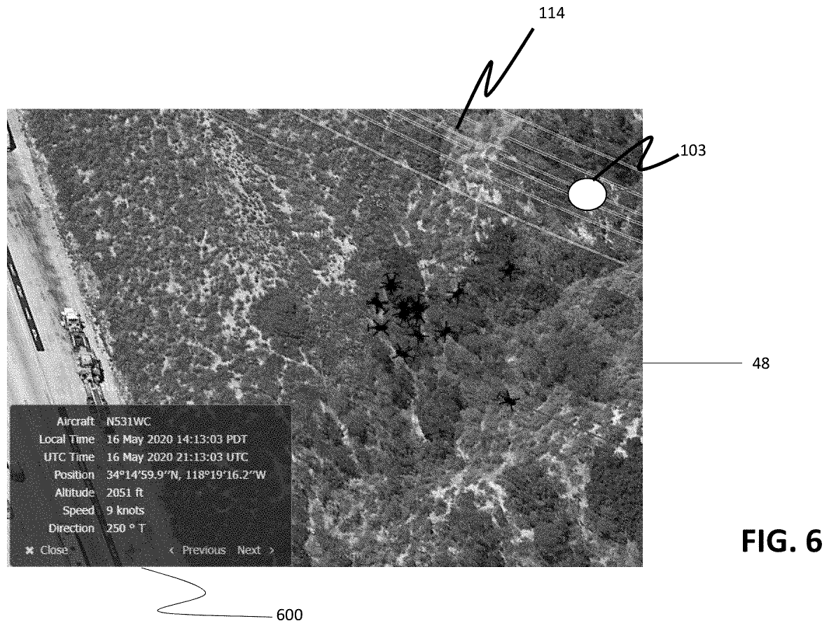

Referring now to FIG. 6, an example of a ground based web portal for a global satellite relocation system is referenced. If the global satellite communication network feature is activated, the pilot will push a switch and hold until a global satellite communication network acknowledgment message is displayed on the LCD. For example, the location of marker ball 103 installed on powerline 114 will be sent to the ground based web portal 48 via the global satellite communication network 42 (as shown in FIG. 1). The information sent appears as inset 600 and includes the aircraft designation number, local time, UTC time, position, altitude, speed, and direction.

In this way, each time a ball is placed a GPS location and be transmitted by, for example, a global satellite communication system, such as that provided by Iridium Communications Inc. of McLean Va., US. Other tracking data is also provided to the ground station.

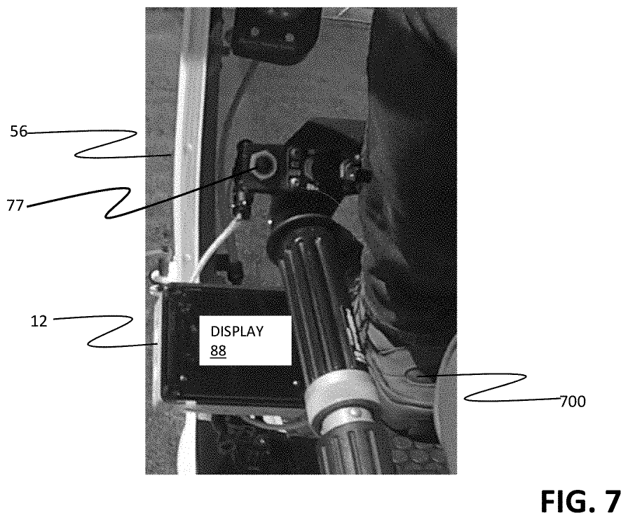

Referring now to FIG. 7, an example of a location control assembly mounted in a helicopter is schematically shown. A helicopter 56 has a locating control assembly 12 mounted therein including a start switch 77. The display 88 is positioned proximate the left leg of the helicopter pilot 700 for easy viewing by the helicopter pilot.

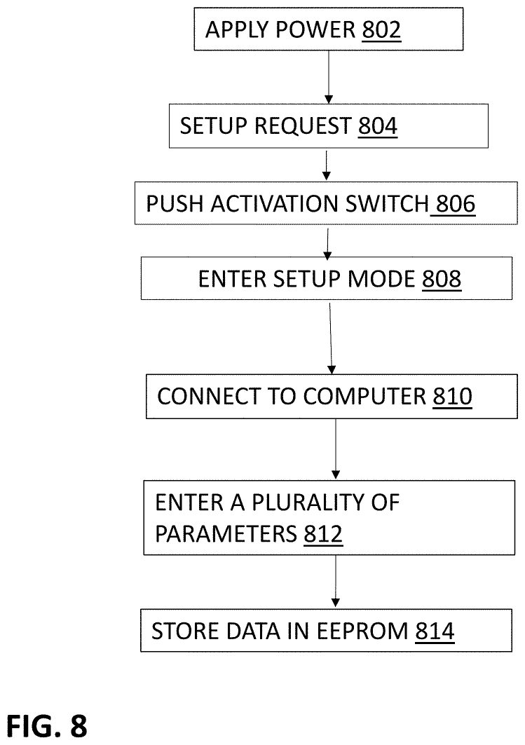

Referring now to FIG. 8, a flow diagram of the method employed by a distance measurement system for guiding a helicopter pilot to locate powerline ball positions it is schematically shown. Having described the components of the high accuracy distant measurement system 10, an explanation of the system and method of operation is provided hereinbelow for promoting further understanding of the system. In one example, power is applied to the system 802 and the MCU sends a message to the LCD display with a “setup” request 804. If the activation switch 77 is pushed within a predetermined time, in one example, about 5 seconds, 806 the system will be in setup mode 808.

In setup mode the LCD display will request that the system be connected by Bluetooth to the computer device 810, such as, for example an external tablet, PC, phone, or the like. Once connected, the activation switch 77 is pushed again and the LCD prompts the user to enter in a plurality of parameters 812, including the following parameters into the computer device 20:
D1: representing an initial offset distance from the structure to the first powerline marker ball location.
D2: representing distance between the first marker ball and the subsequent powerline marker ball locations which will be evenly spaced thereafter.
Number of Balls: representing a value of the total number of balls between powerline structures.
Threshold: representing a value of the distance that the system will automatically transition to the next marker ball distance.
Fields: This allows the user to select what data fields are presented on the display.
Backlite: The display (e.g. LCD display) backlite may be turned On or OFF.
IRIDIUM: This is a function that may be optionally selected. If selected, the marker ball location will be sent via, for example, the IRIDIUM satellite communication system to a ground station. The user then exists this setup mode. All data is stored in a nonvolatile EEPROM onboard the MCU 814.

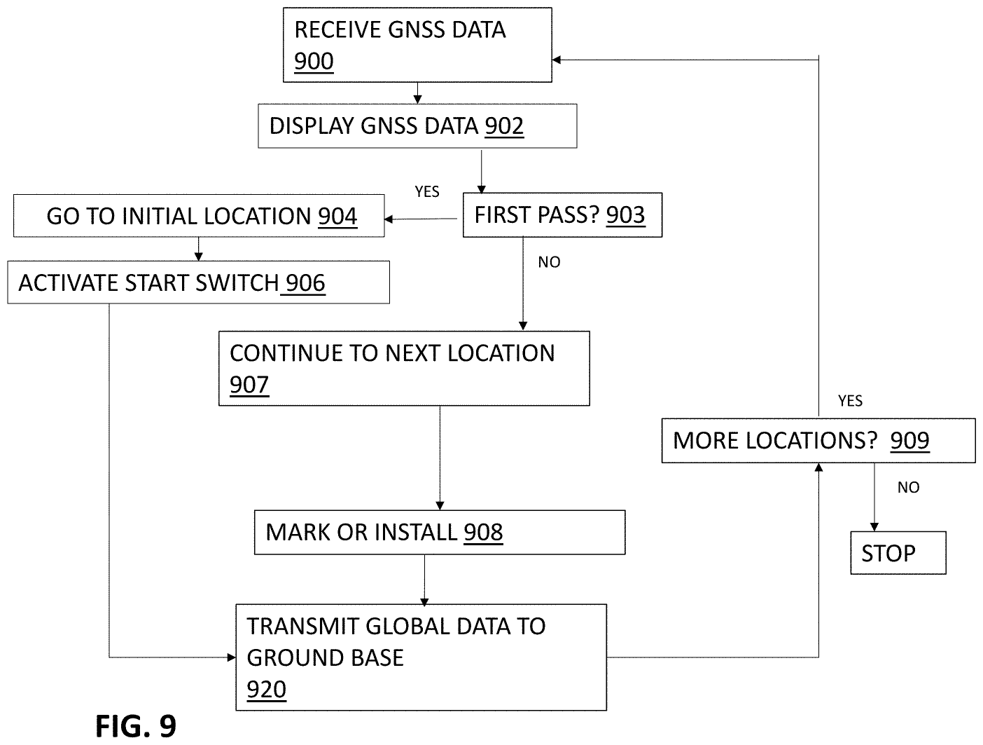

Referring now to FIG. 9, a flow diagram of further actions employed by the method for guiding a helicopter to predetermined powerline ball locations is schematically shown. Having completed the setup actions as shown in FIG. 8, the system components are ready to use in determining powerline ball locations and conveying the locations to a helicopter pilot using the display to provide visual indications of the locations. In a first act 900 the location control assembly 12 communicates with the GNSS satellite system 40 by operating the GNSS module and receiving data from the GPS/GNSS satellite 40 through a first antenna 26. In a second act 902 the helicopter 56 is guided by the control assembly 12 transmitting the GNSS satellite system 40 information via the first serial data line to the display 88 and the display responds with a dynamic visual representation of distance to target. During a first pass 903 the helicopter pilot flies to an initial location 904 and activates a start button marking a start location 906. The process then may optionally transmit global data to a ground base 920. On subsequent passes, the helicopter pilot continues to the next predetermined powerline ball location at act 907 while observing the display 88 which dynamically resolves from a coarse to a fine resolution indicating target distance. At this point the powerline may be marked as with red paint or the powerline ball may be installed if onboard the helicopter 908. If marked with paint, the helicopter will return with the powerline ball to be installed. The helicopter then continues to the next powerline ball location 910 and marks or installs the next ball as needed. As an optional act 920 global satellite communication network data may be transmitted to a ground base. If the total number of locations are not exhausted as queried at act 909, the process is repeated for the next powerline ball location, otherwise the process is stopped.

Certain exemplary embodiments of the invention have been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by different equipment, and devices, and that various modifications, both as to the equipment details and operating procedures, may be accomplished without departing from the true spirit and scope of the present invention.

What is claimed is:

1. A distance measurement location control system for guiding a helicopter pilot to locate powerline marker ball positions with respect to longitudinal displacement, the system comprising:
a location control assembly configured to be mounted in a helicopter in view of a pilot;
a microprocessor module (MCU) onboard the location control assembly;
a computer device configured to receive and transmit setup data from and to the location control assembly;
a GNSS module onboard the location control assembly and electrically connected to the MCU;
a display onboard the location control assembly and connected to a first serial data line from the MCU;
a global satellite communication network module onboard the location control assembly electronically coupled to a second serial data line from the MCU;
a low-power wireless connection module onboard the location control assembly and connected to a third serial data line shared with the MCU for receiving and transmitting the third set of serial data;
where the GNSS module is configured to provide GNSS information to the MCU;
where the MCU is configured to parse the GNSS information and transmit it to the display; and
where the display is configured to provide a visual representation and indicia dynamically representing a distance to a target powerline ball location.

2. The system of claim 1 wherein the setup data comprises a plurality of parameters.

3. The system of claim 2 wherein the plurality of parameters comprises parameters selected from the group consisting of a first offset distance from the structure to a first powerline marker ball location, a second offset distance between the first marker ball and the subsequent powerline marker ball locations which will be evenly spaced thereafter, a total number of balls between powerline structures, a threshold value representing a third distance four automatically transitioning to the next marker ball distance, a data field selection that allows a user to select what data fields are presented on the display, a backlight for the display, and a selection for activating or deactivating communication to a global satellite communication network selection.

4. The system of claim 3 wherein the MCU includes a nonvolatile memory and the computer device transmits the plurality of parameters to the nonvolatile memory.

5. The system of claim 1 wherein the computer device is selected from the group consisting of a personal computer, smart phone, computer, computer tablet and laptop computer.

6. The system of claim 1 wherein the display comprises:
a coarse resolution represented by a plurality of segments and indicia;
a numeric display showing a distance to a current target;
indicia representing distance traveled from a starting point; and
a number of the ball location at the next target.

7. The system of claim 6 wherein, the display is configured to dynamically change in response to the first serial data as the distance to the current target is within the predetermined distance, the coarse resolution transitions to a fine resolution.

8. The system of claim 7 wherein the display dynamically changes in response to the first serial data to show the distance to the next powerline ball target when a predetermined threshold beyond the current target has been exceeded.

9. A distance measurement location control method for guiding a helicopter pilot to locate powerline marker ball positions with respect to longitudinal displacement, the method comprising:
a) setting up a location control assembly with powerline ball parameters including an initial location and a predetermined spacing distance for a predetermined number of powerline balls;
b) receiving GNSS data in a location control assembly;
c) transmitting the GNSS data to a display;
d) automatically operating the display to dynamically indicate a distance to the initial location;
e) flying a helicopter to the initial location;
f) marking the initial location;
g) proceeding to a first predetermined powerline ball location while observing the display which dynamically resolves from a coarse to a fine resolution indicating a target distance;
h) marking the first predetermined powerline ball location;
i) receiving updated GNSS data in a location control assembly;
j) transmitting the updated GNSS data to the display;
k) automatically operating the display to dynamically indicate a distance to the next predetermined powerline ball;
l) proceeding to the next predetermined powerline ball location while observing the display which dynamically resolves from a coarse to a fine resolution indicating a next target distance;
m) marking or installing the next powerline ball; and
n) repeating actions i) through m) until all powerline ball locations have been found.

10. The method of claim 9 wherein setting up a location control assembly comprises:
applying power to the location control assembly;
programming the MCU to transmit a setup message to the display;
using the activation switch to put the location control system in setup mode;
wirelessly connecting a computer device;
using the activation switch to control the display to prompt a user to enter a plurality of parameters into the computer device;
storing the parameters into a memory onboard the MCU.

11. The method of claim 10 wherein entering the plurality of parameters comprises entering parameters selected from the group consisting of a first offset distance from the structure to a first powerline marker ball location; a second offset distance between the first marker ball and the subsequent powerline marker ball locations which will be evenly spaced thereafter; a total number of balls between powerline structures; a threshold value representing a third distance four automatically transitioning to the next marker ball distance; a data field selection that allows a user to select what data fields are presented on the display; a backlight for the display, and a selection for activating or deactivating communication to a global satellite communication network selection.

12. A distance measurement location control system for guiding a helicopter pilot to locate powerline marker ball positions with respect to longitudinal displacement, the system comprising:
a location control assembly configured to be mounted in a helicopter in view of a pilot;
a microprocessor module (MCU) onboard the location control assembly;
setup data including a plurality of parameters selected from the group consisting of a first offset distance from the structure to a first powerline marker ball location, a second offset distance between the first marker ball and the subsequent powerline marker ball locations which will be evenly spaced thereafter, a total number of balls between powerline structures, a threshold value representing a third distance four automatically transitioning to the next marker ball distance, a data field selection that allows a user to select what data fields are presented on the display, a backlight for the display, and a selection for activating or deactivating communication to a global satellite communication network selection;
a computer device configured to receive and transmit the setup data from and to the location control assembly;
a GNSS module onboard the location control assembly and electrically connected to the MCU;
a display onboard the location control assembly and connected to a first serial data line from the MCU, wherein the display includes a coarse resolution represented by a plurality of segments and indicia, a numeric display showing a distance to a current target, indicia representing distance traveled from a starting point, and a number of the ball location at the next target and wherein the display is configured to dynamically change in response to the first serial data as the distance to the current target is within the predetermined distance, the coarse resolution transitions to a fine resolution;
a global satellite communication network module onboard the location control assembly electronically coupled to a second serial data line from the MCU;
a low-power wireless connection module onboard the location control assembly and connected to a third serial data line shared with the MCU for receiving and transmitting the third set of serial data;
where the GNSS module is configured to provide GNSS information to the MCU;
where the MCU is configured to parse the GNSS information and transmit it to the display; and
where the display is configured to provide a visual representation and indicia dynamically representing a distance to a target powerline ball location.

13. The system of claim 12 wherein the MCU includes a nonvolatile memory and the computer device transmits the plurality of parameters to the nonvolatile memory.

14. The system of claim 12 wherein the computer device is selected from the group consisting of a personal computer, smart phone, computer, computer tablet and laptop computer.

15. The system of claim 12 wherein the display dynamically changes in response to the first serial data to show the distance to the next powerline ball target when a predetermined threshold beyond the current target has been exceeded.

16. The system of claim 12 wherein the display is an LCD display.
